(19) United States
(12) Patent Application Publication
(10) Pub. No.: US 2011/0291409 A1
(43) Pub. Date: Dec. 1, 2011

(54) Pipe Gripping Elements with Buttress Pockets and Pipe Joint Restraints Incorporating Same

(76) Inventors: Harold Kennedy, JR., Fuquay Varina, NC (US); Sean M. Emery, Fuquay Varina, NC (US)

(21) Appl. No.: 12/791,453

(22) Filed: Jun. 1, 2010

(51) Int. Cl. F16L 25/06

(52) U.S. Cl. 285/421

(57) ABSTRACT

A pipe gripping element has an arcuate pipe engaging face with opposite front and rear edges, and an elongated, arcuate tooth extending outwardly therefrom between the front and rear edges. A portion of the pipe engaging face between the front edge thereof and the tooth forms a buttress pocket that retains a volume of pipe material displaced when the tooth is extended into a surface of a pipe. The displaced pipe material forms a load bearing buttress that prevents pipe movement. A pipe joint restraint includes an annular retainer gland, a plurality of pockets circumferentially spaced around the gland, and a plurality of pipe gripping elements operably associated therewith for gripping and restraining a pipe. A plurality of stops are associated with a projecting rim of the pipe joint restraint and limit the distance the projecting rim can be inserted within a second pipe fitting.

### FIELD OF THE INVENTION

The present invention relates generally to pipe coupling and, more particularly, to pipe coupling apparatus.

### BACKGROUND

It is often necessary to couple together the end of a pipe, such as a water pipe, to another member, such as another pipe, a valve, a fitting, or other similar pipe-like structure. In some cases, the ends of two adjacent pipes may be flanged, and the flanges can be placed into confronting relationship to facilitate bolting the pipes together. This coupling arrangement, however, is not always feasible or available.

A coupling device known as a mechanical joint can be used where one of the pipes does not have an available flanged end. In that situation, the end of the non-flanged pipe is telescopically received into a flared end of a flanged member, with a follower ring situated over the pipe adjacent to the flange. A gasket is provided which is compressed into the pipe surface and against the flare of the other member to create a water-tight seal as the follower ring is bolted to the flange. An exemplary mechanical joint is the Standardized Mechanical Joint (SMJ), which is described in ANSI/AWWA (American National Standards Institute/American Water Works Association) C111/A21.11.

Mechanical joints are suitable for a number of situations, but may not be able to retain a water-tight connection between the pipes when the pipes are subjected to hydraulic thrust forces which tend to cause the pipes to telescope apart, such as pipes utilized in pressurized municipal and industrial water systems. To reduce the risk of such pipes coming apart, pipe joint restraints may be utilized with mechanical joints or other joints. An exemplary pipe joint restraint is illustrated in FIGS. 1 and 2. The end 12 of a first pipe 14, such as a water main pipe, is secured by the pipe joint restraint 16 to the end 18 of a second pipe-like member 20 which may be, for example, another water main pipe or a pipe-like extension of a valve, fitting, fire hydrant, or other similar structure. The pipe joint restraint 16 has an annular retainer gland 22 that is disposed on the outer surface 28 of first pipe 14. The annular retainer gland 22 defines a pipe receiving space 24 therethrough and has an axial centerline 26. The illustrated annular retainer gland 22 includes a front projecting rim 30 which butts up against an annular sealing member 32, such as a gasket, received on outer surface 28 of the first pipe end 12.

The end 18 of the second pipe 20 is flared as at 34 to telescopically receive the first pipe end 12 therein. The flange 36 of pipe end 18 may be secured to the annular retainer gland 22 with T-bolts 38 (only one shown) received through axially-extending holes 40 and 42 on the gland 22 and flange 36, respectively. The gasket 32 is in a recess 44 that is coaxial with the flange 36 and is sized to receive a portion of rim 30 so as to push the gasket 32 into a water-tight sealing relationship with pipe surface 28 and pipe recess 44 as the T-bolts 38 are tightened down.

The annular retainer gland 22 is secured to the first pipe 14 by one or more pipe restraining mechanisms 50. Each pipe restraining mechanism 50 includes a pocket 60 and a pipe engaging assembly 62 cooperatively coupled to pocket 60. Each pipe engaging assembly 62 includes at least one tooth 75 supported on a gripping element 76, an adjustment member 78, which may be in the form of a bolt, and a nut 80 to receive torque to adjust the bolt. A rotation of the bolt 78, such as via nut 80, causes the gripping element 76 to move radially toward or away from the pipe surface 28, depending on rotational direction. The tooth 75 is configured to engage the pipe surface 28 when the gripping element 76 is moved toward the pipe 14, and to thereafter bite into the pipe surface 28 in response to thrust forces tending to move the pipe ends 12, 18 telescopically apart along the centerline 26. The tooth 75 and groove formed thereby resist the tendency of the pipes to move away from the each other.

High-density polyethylene (HDPE) piping has been in use for many years and is utilized in various municipal and industrial piping systems. HDPE pipe is soft, compared with iron pipe, and can deflect under stress imposed by a pipe joint restraint, such as the pipe joint restraint illustrated in FIGS. 1 and 2. Such deflection can cause the pipe surface to deflect away from a gasket in a conventional pipe joint restraint, and thus not allow adequate sealing. FIG. 3 is a partial, cross sectional view of a tooth 75 of a prior art gripping element 76 engaging an HDPE pipe. The tooth 75 creates a shaving 9 in the pipe surface 28 as the HDPE pipe deflects under stress. The tooth 75 also creates a shaving 9 when the pipe is exposed to internal pressure and/or when the pipe is exposed to thermal contraction. This shaving 9 can roll back on itself and allow a pipe to move longitudinally when subjected to sufficient deflection/stress. As such, conventional pipe joint restraints, such as illustrated in FIGS. 1 and 2, when used with HDPE piping, may allow pipe ends to separate and leak during use.

To address this problem, a stainless steel cylinder (stiffener) is conventionally inserted within an HDPE pipe under the gasket area of a mechanical joint to prevent the pipe from deflecting under stress. U.S. Pat. No. 6,481,762 to Rex describes an exemplary stiffener. Without such a stiffener to support the HDPE pipe wall, radial forces imparted on the pipe can squeeze the pipe into an hourglass shape causing a leak. Unfortunately, stiffeners can be somewhat complex and time consuming to install. In addition, stiffeners can add to the cost of a piping system installation.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a pipe gripping element has an arcuate pipe engaging face with opposite front and rear edges, and an elongated, arcuate tooth extending outwardly therefrom between the front and rear edges. The tooth includes front and rear walls converging to form a gripping edge. A portion of the pipe engaging face between the front edge thereof and the tooth front wall forms a buttress pocket that is configured to retain a volume of pipe material displaced when the tooth is extended into a surface of a pipe. The displaced pipe material within the buttress pocket forms a load bearing buttress and is not allowed to roll back over itself. The buttress of pipe material prevents longitudinal movement of a pipe and, thus, prevents withdrawal of the pipe end from the end of another pipe to which it is joined.

In some embodiments, the portion of the pipe engaging face between the front edge thereof and the tooth front wall is sloped relative to a portion of the pipe engaging face between the rear edge thereof and the tooth rear wall. For example, the sloped pipe engaging face portion may have a conical configuration and may form an angle relative to the tooth front wall of less than about ninety degrees (90°). This angled configuration facilitates the retention of pipe material within buttress pocket when the tooth is embedded within a pipe surface.

A pipe gripping element, according to embodiments of the present invention, may include more than one arcuate tooth for engaging the surface of a pipe. For example, a pair of elongated, arcuate teeth may extend outwardly from a pipe engaging face of a pipe gripping element in adjacent, spaced-apart relationship, each tooth having converging front and rear walls. A portion of the pipe engaging face adjacent to the front wall of each tooth forms a buttress pocket that retains a volume of pipe material displaced when the tooth is extended into a surface of a pipe.

According to some embodiments of the present invention, a pipe gripping element includes a body portion having opposite sides and a pair of arms, each arm extending laterally outward from a respective body portion side to define an elongated, arcuate pipe engaging face having opposite front and rear edges. An elongated, arcuate tooth extends outwardly from the pipe engaging face between the front and rear edges, and has front and rear walls converging to form a gripping edge. A portion of the pipe engaging face between the front edge thereof and the tooth front wall forms a buttress pocket configured to retain a volume of pipe material displaced when the tooth is extended into a surface of a pipe. The body portion includes an upper surface opposite from the pipe engaging face, and a threaded bore extends through the body portion from the upper surface to the pipe engaging face. An adjustment member is threadably coupled to the gripping element via the threaded bore and is configured to move the gripping element relative to a pipe when utilized with a pipe joint restraint.

According to some embodiments of the present invention, a pipe joint restraint for coupling pipe ends in fluid communication and holding the pipes against separation includes an annular retainer gland defining a pipe-receiving space therethrough, and a plurality of pockets associated with the annular retainer gland in circumferential spaced-apart relationship. Each pocket has an opening confronting the pipe-receiving space and a top wall radially outward of the opening. A plurality of pipe gripping elements are received in the pipe-receiving space. Each pipe gripping element has an arcuate pipe engaging face with opposite front and rear edges. An elongated, arcuate tooth extends outwardly from the pipe engaging face between the front and rear edges, and a portion of the pipe engaging face between the front edge thereof and the tooth forms a buttress pocket configured to retain a volume of pipe material displaced when the tooth is extended into a surface of a pipe. An adjustment member extends within each pocket and is operably associated with a respective gripping element. Each adjustment member is configured to move a respective gripping element relative to the top wall of the pocket.

In some embodiments, the retainer gland includes a projecting rim having a forward end edge that is configured to engage a sealing member, such as a gasket, disposed within an internal annular recess of a fitting on a second pipe when the gland is installed on a first pipe. A plurality of stops are associated with the projecting rim and limit a distance the projecting rim can be inserted within the annular recess of the second pipe fitting.

According to some embodiments of the present invention, a pipe joint restraint includes an annular retainer gland that defines a pipe-receiving space therethrough and that has a projecting rim with a forward end edge for engaging a sealing member disposed within an internal annular recess of a fitting on a second pipe when the gland is installed on a first pipe. A plurality of stops are associated with the projecting rim and are configured to limit a distance the projecting rim can be inserted within the annular recess of the second pipe fitting. The plurality of stops are circumferentially spaced-apart adjacent to the projecting rim.

Pipe gripping elements, according to embodiments of the present invention, are advantageous because pipe joint restraints utilizing these gripping elements allow HDPE pipe to be used in pressurized municipal and industrial piping systems as easily as PVC and ductile iron pipe. Embodiments of the present invention allow the use of standardized mechanical joint fittings, valves and fire hydrants with HDPE pipe without the use of an insert or stiffener and without requiring a large amount of torque which can cause pipe deflection.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 is a cross-sectional view of a pair of pipes coupled together by a conventional pipe joint restraint.

FIG. 2 is a perspective view of the pipe joint restraint of FIG. 1.

FIG. 3 is a partial, cross sectional view of a tooth of a gripping element in the pipe joint restraint of FIG. 2 engaging a pipe.

FIG. 4 is a front perspective view of a pipe joint restraint, according to some embodiments of the present invention.

FIG. 5 is a rear perspective view of the pipe joint restraint of FIG. 4.

FIG. 6 is a perspective view of a pipe gripping element, according to some embodiments of the present invention.

FIG. 7 is a partial, cross sectional view of the tooth and buttress pocket of the gripping element of FIG. 6 engaging a pipe.

FIG. 8 is an exploded perspective view of a pipe gripping element assembly, according to some embodiments of the present invention.

FIG. 9 is a partial, cross sectional view of a pipe joint restraint illustrating a gripping element tooth extended into the surface of a pipe and a pocket configured to retain a volume of displaced pipe material, according to some embodiments of the present invention.

FIG. 10A is a partial, cross sectional view of a pipe joint restraint illustrating a gripping element with a pair of teeth and respective pockets for retaining displaced pipe material, according to some embodiments of the present invention.

FIG. 10B illustrates the gripping element of FIG. 10A engaging a pipe after pressurization of the pipe.

FIGS. 11-14 are partial, cross sectional views of various types of pipe joint restraints that can incorporate gripping elements, according to embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain features or elements may be exaggerated for clarity, and broken lines, if present, may illustrate optional features or operations unless specified otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another elements) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features/elements, these features/elements should not be limited by these terms. These terms are only used to distinguish one feature/element from another feature/element. Thus, a first feature/element discussed below could be termed a second feature/element, and similarly, a second feature/element discussed below could be termed a first feature/element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

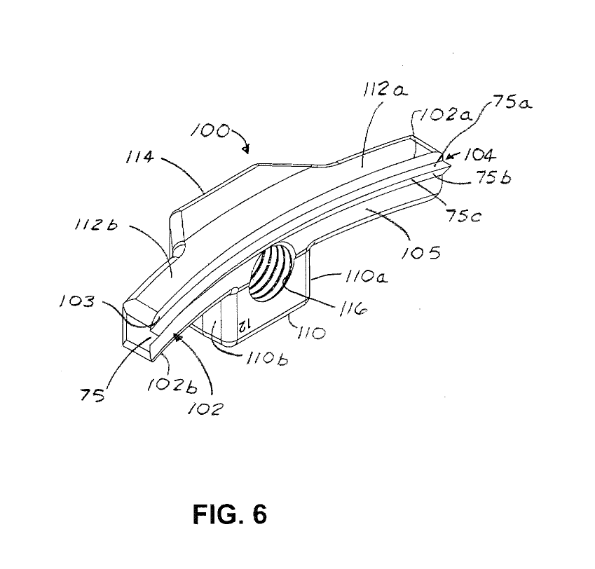

Referring initially to FIG. 6, a pipe gripping element 100 for a pipe joint restraint (16, FIG. 4), according to some embodiments of the present invention, is illustrated. The pipe gripping element 100 has an arcuate pipe engaging face 102 with opposite front and rear edges 102a, 102b. An elongated, arcuate pipe engagement tooth 75 extends outwardly from the pipe engaging face 102 between the front and rear edges 102a, 102b, as illustrated. The tooth 75 has a front wall 75a and a rear wall 75b that converge to form a gripping edge 75c. A portion 103 of the pipe engaging face 102 between the front edge 102a thereof and the tooth 75 forms a buttress pocket 104 configured to retain a volume of pipe material displaced when the tooth 75 is extended into a surface of a pipe, such as an HDPE pipe, or other type of polymeric pipe. The buttress pocket 104 is defined by pipe engaging face portion 103 and the tooth front wall 75a.

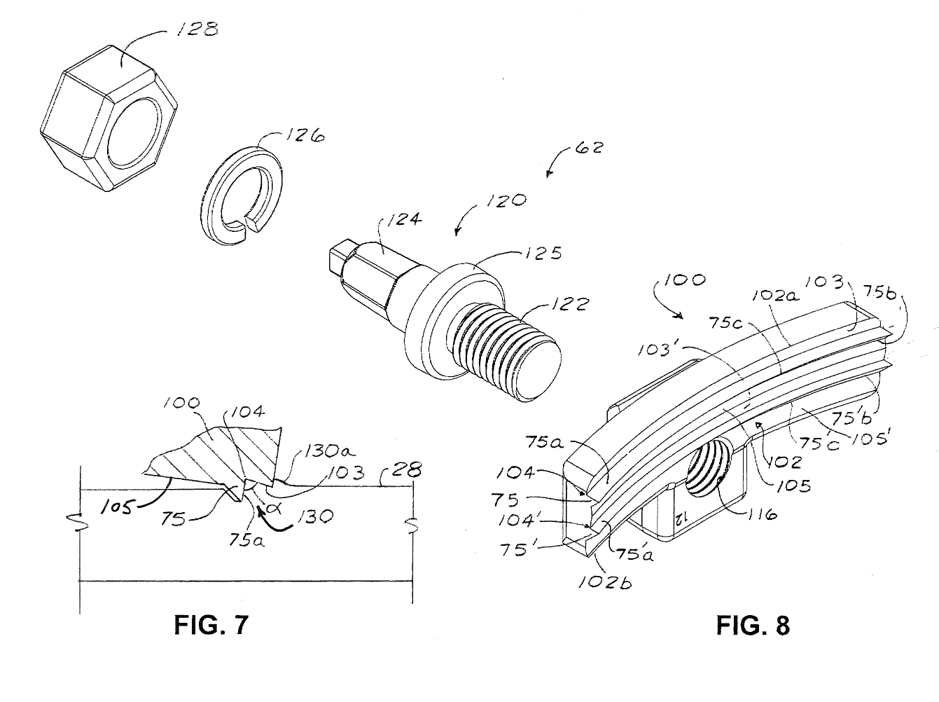

In some embodiments, the pipe engaging face portion 103 is sloped relative to a portion 105 of the pipe engaging face between the rear edge 102b thereof and the tooth rear wall 75b. For example, in the illustrated embodiment, the angle and curvature of the pipe engaging face portion 103 gives it a conical configuration. The curvature of the pipe engaging face portion 105 gives it a cylindrical configuration. In the illustrated embodiment, and best seen in FIG. 7, the pipe engaging face portion 103 and the tooth front wall 75a form an angle α of less than about ninety degrees (90°). This angled configuration of pipe engaging face portion 103 and tooth front wall 75a facilitates the retention of pipe material within the buttress pocket 104 when the tooth 75 is embedded within the pipe surface. However, embodiments of the present invention are not limited to this configuration. The pipe engaging face portion 103 and tooth front wall 75a may form various angles and a buttress pocket 104 can have various shapes, without limitation. In some embodiments, the pipe engaging face portion 103 has a conical slope of about ten degrees (10°) relative to horizontal.

In FIG. 7, the tooth 75 is embedded within a pipe surface 28 to create a groove. The displaced material is retained within the buttress pocket 104. The combination of the groove and buttress of material within the buttress pocket 104 increases the thrust resistance of the gripping element 100. In addition, some of the pipe surface material is urged outwardly at the leading edge of the pipe engaging face portion 103 and forms a second buttress of material 130a, which further increases the thrust resistance of the gripping element 100.

In the illustrated embodiment, the tooth front wall 75a is substantially perpendicular to the pipe engaging face portion 105. In addition, the illustrated tooth gripping edge 75c has an arcuate shape that substantially conforms to an arcuate shape of an outer surface of a pipe.

Referring back to FIG. 6, the illustrated gripping element 100 includes a body portion 110 having opposite sides 110a, 110b, and a pair of arms 112a, 112b. Each arm 112a, 112b extends laterally outward from a respective body portion side, as illustrated. The arms 112a, 112b define the elongated, arcuate pipe engaging face 102 having opposite front and rear edges 102a, 102b. The illustrated body portion 110 also includes an upper surface 114 that is opposite from the pipe engaging face 102. A threaded bore 116 extends through the body portion from the upper surface 114 to the pipe engaging face 102, as illustrated, and is configured to threadably receive an adjustment member.

An exemplary adjustment member 120 is illustrated in FIG. 8. The illustrated adjustment member 120 includes a proximal portion 122 and an opposite distal portion 124 that are separated by an annular shoulder portion 125. The proximal portion 122 is threaded and is configured to be threadably coupled to the gripping element 100 via the threaded bore 116. The distal portion 124 is configured to be engaged by a nut 128 and washer 126, such as a lock washer. The nut 128 is configured to be engaged by a wrench such that the adjustment member 120 can be rotated to move the gripping element 100 toward and away from the surface of a pipe when the gripping element 100 is installed in a pipe joint restraint.

Collectively, the gripping element 100, adjustment member 120, and nut 128 are referred to as a pipe engaging assembly 62. A pipe joint restraint (16, FIG. 4), according to embodiments of the present invention, will have a retainer gland with a plurality of circumferentially spaced-apart pockets 60, each with a respective pipe engaging assembly 62 operably associated therewith.

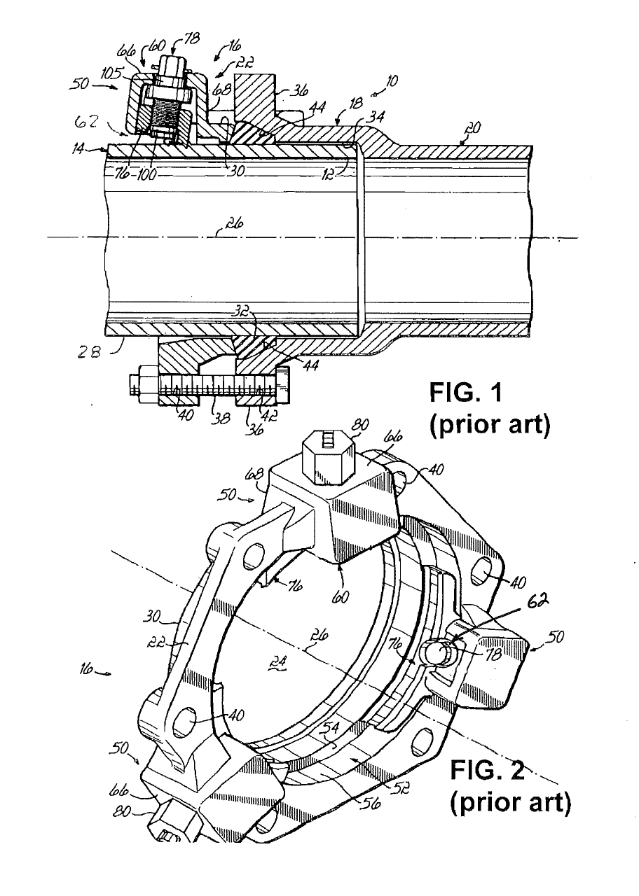

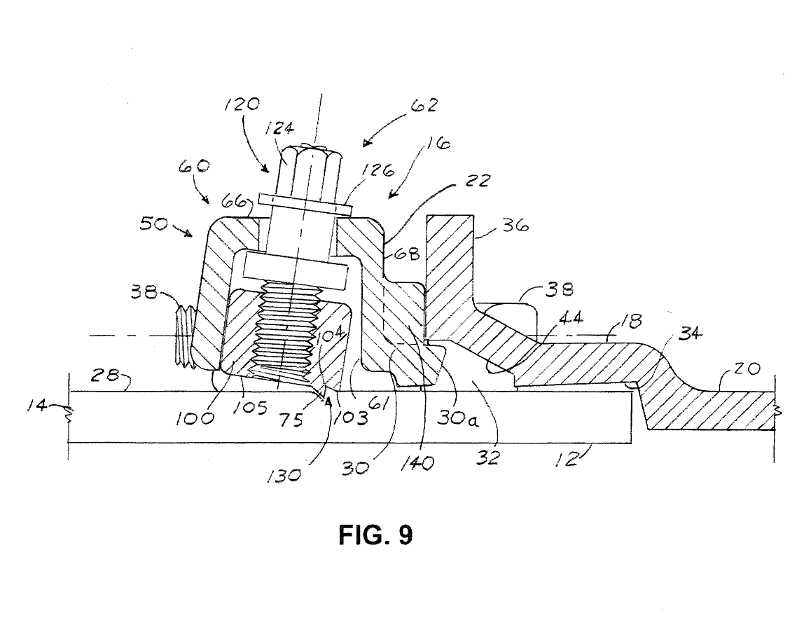

Referring now to FIG. 9, a pipe engaging assembly 62 utilizing the gripping element 100 of FIG. 6 is installed for use within a respective pocket 60 of a pipe joint restraint 16, according to some embodiments of the present invention. The annular retainer gland 22 of the pipe joint restraint 16 is disposed on the outer surface 28 of a first pipe 14 and includes a front projecting rim 30 which butts up against an annular sealing member 32, such as a gasket, received on the outer surface 28 of the pipe end 12. The end 18 of the second pipe 20 is flared as at 34 to telescopically receive the first pipe end 12 therein. The flange 36 of the second pipe end 18 is secured to the annular retainer gland 22 with T-bolts 38 (only one shown), as described above with respect to FIG. 1. The gasket 32 is in a recess 44 that is coaxial with the flange 36 and is sized to receive a portion of the retainer gland projecting rim 30 so as to push the gasket 32 into a water-tight sealing relationship with pipe surface 28 and pipe recess 44 as the T-bolts 38 are tightened down.

The annular retainer gland 22 is secured to the first pipe 14 by one or more pipe restraining mechanisms 50. Each pipe restraining mechanism 50 includes a pocket 60 and a pipe engaging assembly 62 cooperatively coupled thereto. The pipe gripping element 100 of each pipe engaging assembly 62 includes a tooth 75 and an adjacent buttress pocket 104, as described above.

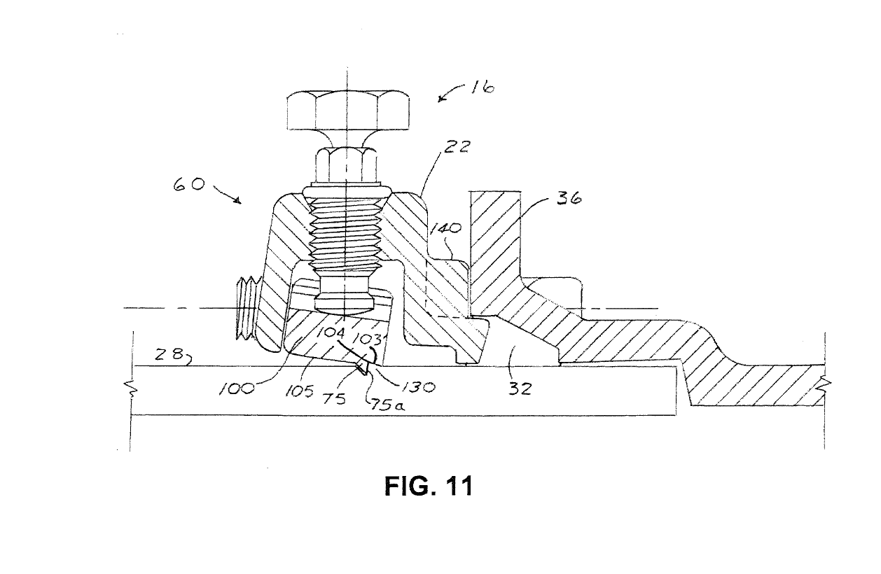

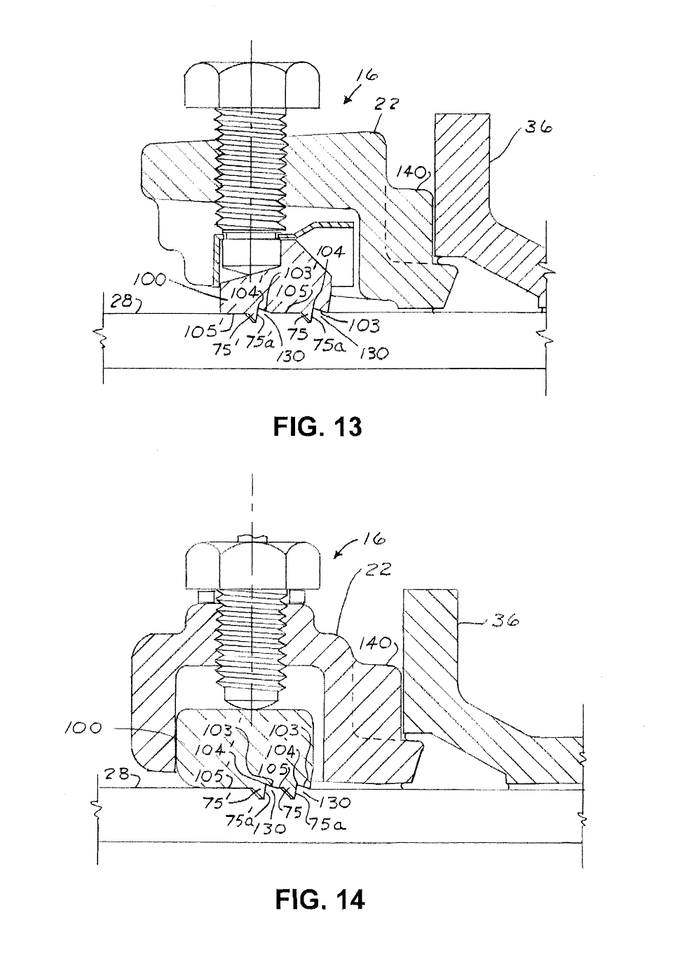

Each pocket 60 has an opening 61 that confronts the pipe-receiving space of the retainer gland 22 and a top wall 66 radially outward of the opening 61. An adjustment member 120 extends within each pocket 60 and is operably associated with (e.g., threadably couples) a respective gripping element 100. The adjustment member 120 is configured to move the gripping element 100 relative to the top wall 66 of the pocket 60. For example, rotation of the adjustment member 120 via a nut (not shown) engaged with adjustment member distal end 124, causes the gripping element 100 to move radially toward or away from the pipe surface 28, depending on the rotational direction. Pipe engaging assemblies utilized in other types of pipe joint restraints may include adjustment members that are operably associated with respective gripping elements in other ways. For example, as illustrated in FIGS. 11, 13 and 14, adjustment members may be operably associated with respective gripping elements without the use of threads. For example, FIG. 11 illustrates an adjustment member coupled to the gripping element with a dovetail joint. FIG. 13 illustrates a component which suspends a gripping element at the end of the adjustment member. FIG. 14 illustrates a gripping element held within a pocket with a shearable substance (e.g., hot glue, etc.) injected into a keyway.

Referring back to FIG. 9, the tooth 75 is configured to engage the pipe surface 28 when the gripping element 100 is moved toward the pipe 14, and to thereafter bite into the pipe surface 28 in response to thrust forces tending to move the pipe ends 12, 18 telescopically apart. The buttress pocket 104 adjacent to the tooth 75 is configured to retain a volume of pipe material displaced when the tooth 75 is extended into the 28 surface of the pipe 14.

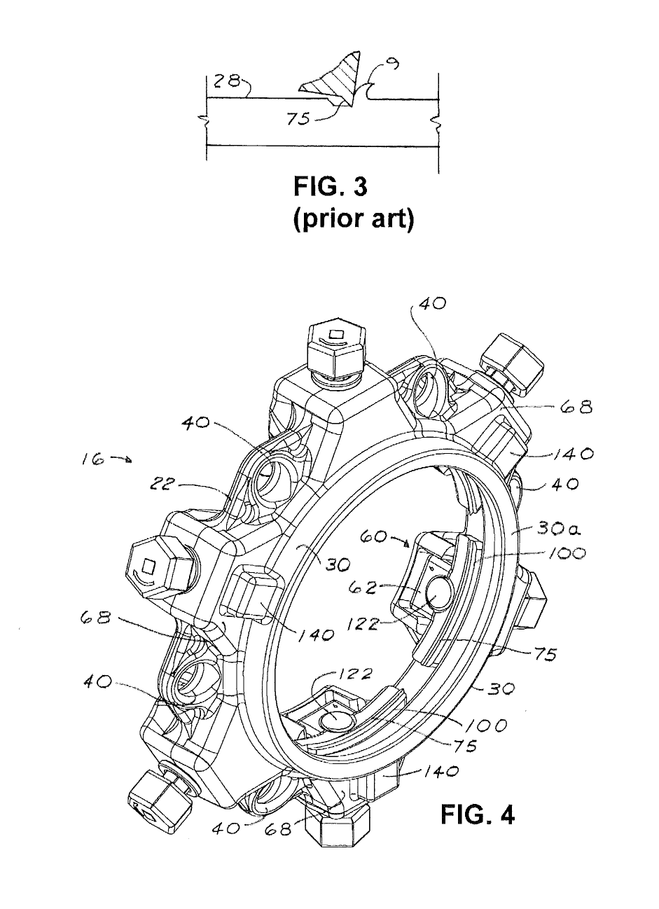

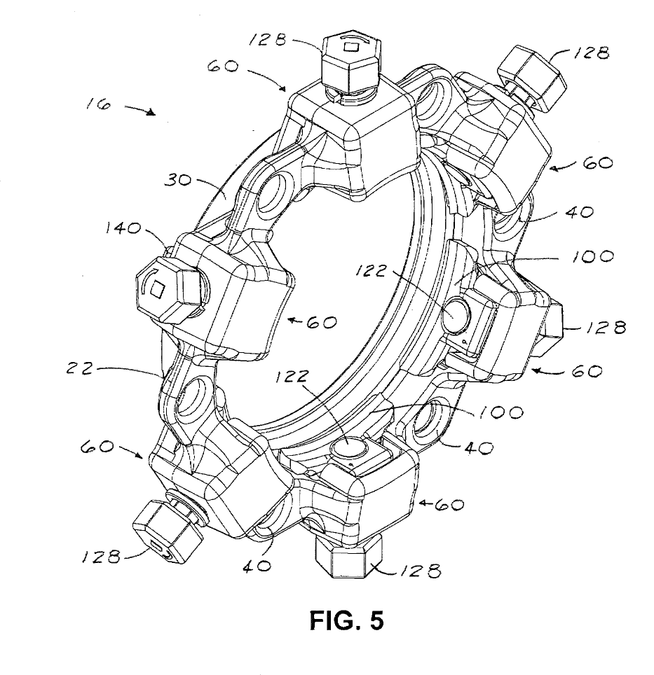

When the tooth 75 of a conventional gripping element (e.g., 76, FIG. 1) bites into the pipe surface 28 of a pipe, such as an HDPE pipe, a groove is cut in the pipe surface 28 creating a shaving (9, FIG. 3) in front of the tooth 75, as described above. The buttress pocket 104 of the present invention traps and confines the HDPE material removed and does not allow a shaving to form. Thus, instead of a shaving, which can roll over on itself and allow pipe movement, a load bearing buttress 130 of pipe material is created which resists pipe movement caused by internal pressure, Poisson effect, thermal contraction, etc. The tooth 75 of a gripping element 100 creates a thrust resisting groove in a pipe surface. Applicants have found that the addition of a load bearing buttress 130 can increase the shear strength of a single thrust resisting groove formed by a tooth 75 in an HDPE pipe by at least 50%. As such, gripping elements according to embodiments of the present invention increase the thrust resisting strength of HDPE pipe (as well as all other polymeric pipe) without requiring conventional stiffeners or other devices.

Gripping elements, according to embodiments of the present invention, are not limited to having a single pipe engagement tooth. Multiple teeth may be utilized in order to increase the thrust resistance of a gripping element. For example, as illustrated in FIG. 8, a pipe gripping element 100 includes a pair of teeth 75, 75′. The pipe gripping element 100 has an arcuate pipe engaging face 102 with opposite front and rear edges 102a, 102b. First and second elongated, arcuate teeth 75, 75′ extend outwardly from the pipe engaging face 102 in spaced-apart relationship between the front and rear edges 102a, 102b of the pipe engaging face 102.

The first tooth 75 has a front wall 75a and a rear wall 75b that converge to form a gripping edge 75c. A portion 103 of the pipe engaging face 102 between the front edge 102a thereof and the first tooth 75 forms a buttress pocket 104 with the first tooth front wall 75a that is configured to retain a volume of pipe material displaced when the tooth 75 is extended into a surface of a pipe. The pocket 104 is defined by pipe engaging face portion 103 and the tooth front wall 75a. The second tooth 75′ has a front wall 75′a and a rear wall 75′b that converge to form a gripping edge 75′c. A portion 103′ of the pipe engaging face 102 adjacent to the second tooth front wall 75′a forms a buttress pocket 104′ with the second tooth front wall 75′a that is configured to retain a volume of pipe material displaced when the second tooth 75′ is extended into a surface of a pipe.

In the illustrated embodiment of FIG. 8, the pipe engaging face portion 103 is sloped relative to the pipe engaging face portion 105 adjacent to the first tooth rear wall 75b, and the pipe engaging face portion 103′ is sloped relative to the pipe engaging face portion 105′ between the second tooth 75′ and the pipe engaging face rear edge 102b. For example, in the illustrated embodiment, the angle and curvature of the pipe engaging face portions 103 and 103′ gives each a conical configuration. The curvature of the pipe engaging face portions 105 and 105′ gives each a cylindrical configuration. The pipe engaging face portion 103 and the first tooth front wall 75a form an angle of less than about ninety degrees (90°). Similarly, the pipe engaging face portion 103′ and the second tooth front wall 75′a form an angle of less than about ninety degrees (90°). This angled configuration of pipe engaging face portion 103 and the first tooth front wall 75a, and pipe engaging face portion 103′ and the second tooth front wall 75′a facilitates the retention of pipe material within the buttress pockets 104, 104′ when the first and second teeth 75, 75′, respectively, are embedded within a pipe surface.

Still referring to FIG. 8, in the illustrated embodiment, the first tooth front wall 75a is substantially perpendicular to the pipe engaging face portion 105, and the second tooth front wall 75′a is substantially perpendicular to the pipe engaging face portion 105′. In addition, the first and second teeth gripping edges 75c, 75′c each have an arcuate shape that substantially conforms to an arcuate shape of an outer surface of a pipe. Pipe gripping elements according to embodiments of the present invention are not limited to a single pipe engagement tooth or to a pair of pipe engagement teeth. In some embodiments, a pipe gripping element may have more than two pipe engagement teeth.

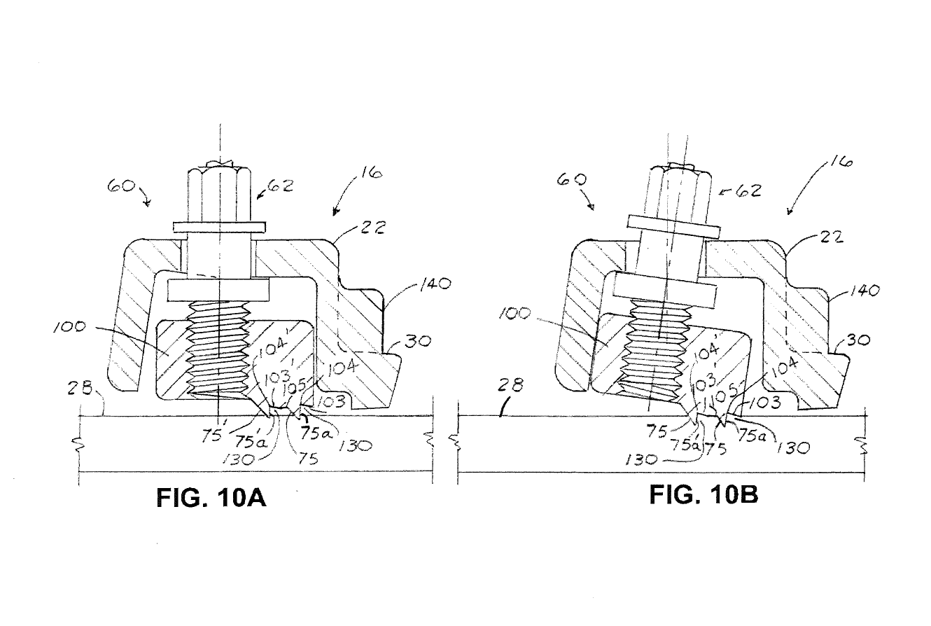

FIGS. 10A and 10B are partial, cross sectional views of a pipe joint restraint 16 utilizing the gripping element 100 of FIG. 8. In FIG. 10A, the first and second teeth 75, 75′ are engaged with the surface 28 of a pipe. In FIG. 10B, the first and second teeth 75, 75′ are further embedded into the pipe surface 28 in response to thrust forces exerted on the pipes as a result of pressurization, thermal contraction, etc., as described above. The respective buttress pockets 104, 104′ adjacent to the teeth 75, 75′ each retain a volume of pipe material displaced when the teeth 75, 75′ extend into the surface 28, as illustrated. The pockets 104, 104′ prevent the retained material from rolling over and allowing the pipe to move.

The number of gripping elements 100 required for a particular piping application can be determined by calculating the minimum length (L) of teeth needed. The value of L (in inches) is determined by the following equation:

L=PD²/1452

where P represents pressure (pounds per square inch) within a pipe to which the retainer gland is to be secured, and wherein D represents the outside diameter of the pipe in inches. Once the value of L is known, the number of gripping elements 100 can be selected. For example, if the value of L is 30 inches, six gripping elements, each having a tooth with a length of 5 inches can be utilized, or five gripping elements each having a tooth with a length of 6 inches can be utilized, etc. By calculating the minimum length of teeth necessary to create grooves sufficient to resist pipe movement, the number of teeth for larger pipe sizes can be kept to a minimum. As such, the radial contact stress and therefore the radial force to create the grooves can be kept to a minimum in order to prevent a pipe surface from deflecting away from the pipe joint restraint gasket (i.e., 32, FIG. 9). Applicants have also discovered that the total required length of a tooth with an adjacent buttress pocket is ⅔ the length required without a buttress pocket. This reduction is significant in that it follows that only ⅔ the radial force is required to create a groove and therefore the deflection of a pipe surface away from a sealing member can be reduced by the same amount.

Gripping elements including a pipe engagement tooth and adjacent buttress pocket, according to embodiments of the present invention, allow low torque to be applied to adjustment members (120, FIG. 8) associated with these gripping elements. For example, a torque in the range of 20-60 ft-lbs is typically sufficient, with only 30 ft-lbs typically needed.

Still referring to FIG. 9, the retainer gland 22 of the illustrated pipe joint restraint includes a projecting rim 30 having a forward end edge 30a that engages a sealing member 32, such as a gasket, disposed within an internal annular recess 44 of a second pipe 20 when the gland 22 is installed on a first pipe 14. A plurality of stops 140 are associated with the projecting rim 30 and are configured to limit the distance the projecting rim 30 can be inserted within the annular recess 44 of the second pipe fitting 36. FIG. 4 is a perspective view of the retainer gland 22 of FIG. 9 illustrating the plurality of stops 140 arranged in circumferentially spaced relationship, according to some embodiments. In the illustrated embodiment of FIG. 4, three stops 140 are utilized. However, more stops 140 or fewer stops 140 may be utilized in other embodiments.

In the illustrated embodiment, each stop 140 is connected to the front wall 68 of a respective pocket 60 and to the projecting rim 30 and has a generally rectangular configuration. Embodiments of the present invention, however, are not limited to a particular configuration or number of stops 60.

Gripping elements 100, as described herein, can be incorporated into any type of pipe joint restraint that utilizes individually activated gripping elements. Exemplary, pipe joint restraints that may utilize gripping elements 100 according to embodiments of the present invention include, but are not limited to, those described in U.S. Pat. No. 7,484,775 to Kennedy, U.S. Pat. No. 4,092,036 to Sato, U.S. Pat. No. 6,322,273 to Gentile, U.S. Pat. No. 5,071,175 to Kennedy, U.S. Pat. No. 6,173,993 to Shumard, and U.S. Pat. No. 7,185,924 to Longacre, each of which are incorporated herein by reference in their entireties.

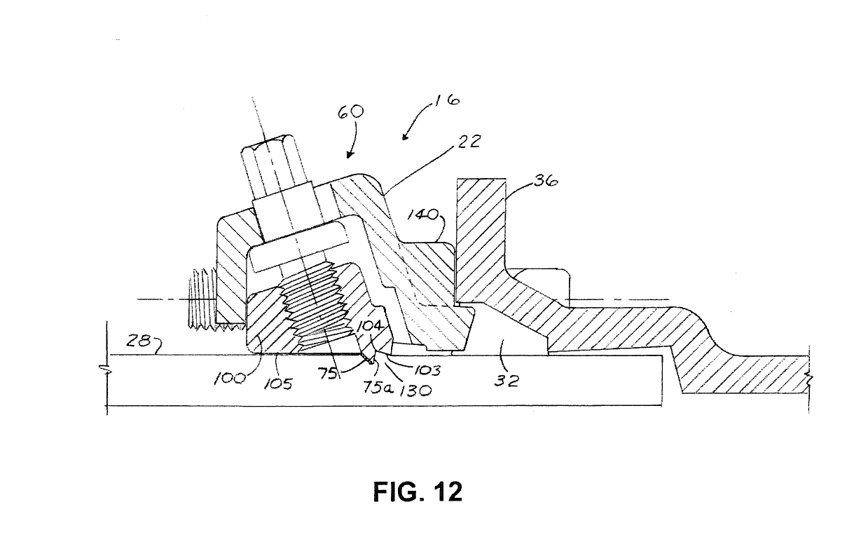

FIGS. 11-14 are partial, cross sectional views of various types of pipe joint restraints that can incorporate gripping elements, according to embodiments of the present invention. For example, FIG. 11 illustrates a retainer gland of a pipe joint restraint disclosed in U.S. Pat. No. 6,322,273 that includes pipe gripping elements 100, and projection rim stops 140, according to embodiments of the present invention. FIG. 12 illustrates a retainer gland of a pipe joint restraint disclosed in U.S. Pat. No. 4,092,036 that includes pipe gripping elements 100, and projection rim stops 140, according to embodiments of the present invention. FIG. 13 illustrates a retainer gland of a pipe joint restraint disclosed in U.S. Pat. No. 6,173,993 that includes pipe gripping elements 100, and projection rim stops 140, according to embodiments of the present invention. FIG. 14 illustrates a retainer gland of a pipe joint restraint disclosed in U.S. Pat. No. 5,071,175 that includes pipe gripping elements 100, and projection rim stops 140, according to embodiments of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A pipe gripping element comprising an arcuate pipe engaging face having opposite front and rear edges, an elongated, arcuate tooth extending outwardly from the pipe engaging face between the front and rear edges, wherein a portion of the pipe engaging face between the front edge thereof and the tooth forms a pocket configured to retain a volume of pipe material displaced when the tooth is extended into a surface of a pipe.

2. The pipe gripping element of claim 1, wherein the tooth comprises front and rear walls converging to form a gripping edge.

3. The pipe gripping element of claim 2, wherein a portion of the pipe engaging face between the front edge thereof and the tooth front wall is sloped relative to a portion of the pipe engaging face between the rear edge thereof and the tooth rear wall.

4. The pipe gripping element of claim 2, wherein a portion of the pipe engaging face between the front edge thereof and the tooth front wall forms an angle with the tooth front wall of less than ninety degrees (90°).

5. The pipe gripping element of claim 2, wherein a portion of the pipe engaging face between the front edge thereof and the tooth front wall is conical.

6. The pipe gripping element of claim 2, wherein the tooth front wall is substantially perpendicular to a portion of the pipe engaging face extending between the rear edge thereof and the tooth rear wall.

7. The pipe gripping element of claim 2, wherein the tooth gripping edge conforms to an arcuate shape of an outer surface of a pipe.

8. The pipe gripping element of claim 1, further comprising a second elongated, arcuate tooth extending outwardly from the pipe engaging face between the first tooth and the pipe engaging face rear edge, and wherein a portion of the pipe engaging face between the first and second teeth and adjacent to the second tooth forms a pocket configured to retain a volume of pipe material displaced when the second tooth is extended into a surface of a pipe.

9. A pipe gripping element comprising:
a body portion having opposite sides;
a pair of arms, each extending laterally outward from a respective body portion side and defining an elongated, arcuate pipe engaging face having opposite front and rear edges; and
an elongated, arcuate tooth extending outwardly from the pipe engaging face between the front and rear edges, the tooth comprising front and rear walls converging to form a gripping edge, and wherein a portion of the pipe engaging face between the front edge thereof and the tooth front wall forms a pocket configured to retain a volume of pipe material displaced when the tooth is extended into a surface of a pipe.

10. The pipe gripping element of claim 9, wherein a portion of the pipe engaging face between the front edge thereof and the tooth front wall is sloped relative to a portion of the pipe engaging face between the rear edge thereof and the tooth rear wall.

11. The pipe gripping element of claim 9, wherein a portion of the pipe engaging face between the front edge thereof and the tooth front wall forms an angle with the tooth front wall of less than ninety degrees (90°).

12. The pipe gripping element of claim 9, wherein a portion of the pipe engaging face between the front edge thereof and the tooth front wall is conical.

13. The pipe gripping element of claim 9, wherein the tooth front wall is substantially perpendicular to a portion of the pipe engaging face extending between the rear edge thereof and the tooth rear wall.

14. The pipe gripping element of claim 9, wherein the tooth gripping edge conforms to an arcuate shape of an outer surface of a pipe.

15. The pipe gripping element of claim 9, wherein the body portion comprises an upper surface opposite from the pipe engaging face, and wherein a threaded bore extends through the body portion from the upper surface to the pipe engaging face.

16. The pipe gripping element of claim 15, further comprising an adjustment member threadably coupled to the gripping element via the threaded bore.

17. The pipe gripping element of claim 9, further comprising a second elongated, arcuate tooth extending outwardly from the pipe engaging face between the first tooth and the pipe engaging face rear edge, and wherein a portion of the pipe engaging face between the first and second teeth and adjacent to the second tooth forms a pocket configured to retain a volume of pipe material displaced when the second tooth is extended into a surface of a pipe.

18. The pipe gripping element of claim 17, wherein a portion of the pipe engaging face adjacent to the second tooth front wall is sloped relative to a portion of the pipe engaging face adjacent to the second tooth rear wall.

19. The pipe gripping element of claim 17, wherein a portion of the pipe engaging face adjacent to the second tooth front wall forms an angle with the second tooth front wall of less than ninety degrees (90°).

20. The pipe gripping element of claim 17, wherein a portion of the pipe engaging face adjacent to the second tooth front wall is conical.

21. The pipe gripping element of claim 17, wherein the second tooth front wall is substantially perpendicular to a portion of the pipe engaging face adjacent to the second tooth rear wall.

22. The pipe gripping element of claim 17, wherein the gripping edge of the second tooth conforms to an arcuate shape of an outer surface of a pipe.

23. A pipe joint restraint for coupling pipe ends in fluid communication and holding the pipes against separation, comprising:
an annular retainer gland defining a pipe-receiving space therethrough;
a plurality of pockets associated with the annular retainer gland in circumferential spaced-apart relationship, each pocket having an opening confronting the pipe-receiving space and a top wall radially outward of the opening;
a plurality of pipe gripping elements received in the pipe-receiving space, each pipe gripping element comprising an arcuate pipe engaging face having opposite front and rear edges, an elongated, arcuate tooth extending outwardly from the pipe engaging face between the front and rear edges, and wherein a portion of the pipe engaging face between the front edge thereof and the tooth forms a pocket configured to retain a volume of pipe material displaced when the tooth is extended into a surface of a pipe; and
a plurality of adjustment members, each extending within a respective pocket and operably associated with a respective gripping element and adapted to move the gripping element relative to the top wall of the pocket.

24. The pipe joint restraint of claim 23, wherein each pipe gripping element tooth comprises front and rear walls converging to form a gripping edge.

25. The pipe joint restraint of claim 24, wherein, for each pipe gripping element, a portion of the pipe engaging face between the front edge thereof and the tooth front wall is sloped relative to a portion of the pipe engaging face between the rear edge thereof and the tooth rear wall.

26. The pipe joint restraint of claim 24, wherein, for each pipe gripping element, a portion of the pipe engaging face between the front edge thereof and the tooth front wall forms an angle with the tooth front wall of less than ninety degrees (90°).

27. The pipe joint restraint of claim 24, wherein, for each pipe gripping element, a portion of the pipe engaging face between the front edge thereof and the tooth front wall is conical.

28. The pipe joint restraint of claim 24, wherein, for each pipe gripping element, the tooth front wall is substantially perpendicular to the portion of the pipe engaging face extending between the rear edge thereof and the tooth rear wall.

29. The pipe joint restraint of claim 23, wherein, for each pipe gripping element, the tooth gripping edge conforms to an arcuate shape of an outer surface of a pipe.

30. The pipe joint restraint of claim 23, wherein each pipe gripping element further comprises a second elongated, arcuate tooth extending outwardly from the pipe engaging face between the first tooth and the pipe engaging face rear edge, and wherein a portion of the pipe engaging face between the first and second teeth and adjacent to the second tooth forms a pocket configured to retain a volume of pipe material displaced when the second tooth is extended into a surface of a pipe.

31. The pipe joint restraint of claim 30, wherein, for each pipe gripping element, each second tooth comprises front and rear walls converging to form a gripping edge.

32. The pipe joint restraint of claim 30, wherein, for each pipe gripping element, the second tooth gripping edge conforms to an arcuate shape of an outer surface of a pipe.

33. The pipe joint restraint of claim 30, wherein each pipe gripping element comprises:
a body portion having opposite sides; and
a pair of arms, each extending laterally outward from a respective body portion side to define the elongated, arcuate pipe engaging face.

34. The pipe joint restraint of claim 23, wherein a total length L of the gripping teeth for the plurality of gripping elements is determined by the equation L=PD²/1452, wherein P represents pressure within a pipe to which the pipe joint restraint is to be secured, and wherein D represents the outside diameter of the pipe.

35. The pipe joint restraint of claim 23, the gland further including a plurality of bolt holes for receiving bolts to fasten the gland to a flange of a member receiving an end of a pipe received in the pipe-receiving space of the gland.

36. The pipe joint restraint of claim 23, further comprising a projecting rim having a forward end edge for engaging a sealing member disposed within an internal annular recess of a fitting on a second pipe when the gland is installed on a first pipe, and a plurality of stops associated with the projecting rim that limit a distance the projecting rim can be inserted within the annular recess of the second pipe fitting.

37. A pipe joint restraint for coupling pipe ends in fluid communication and holding the pipes against separation, the gland comprising:
an annular retainer gland defining a pipe-receiving space therethrough and having a projecting rim with a forward end edge for engaging a sealing member disposed within an internal annular recess of a fitting on a second pipe when the gland is installed on a first pipe;
a plurality of stops associated with the projecting rim that limit a distance the projecting rim can be inserted within the annular recess of the second pipe fitting;
a plurality of pockets associated with the annular retainer gland in circumferential spaced-apart relationship, each pocket having an opening confronting the pipe-receiving space and a top wall radially outward of the opening;
a plurality of pipe gripping elements received in the pipe-receiving space; and
a plurality of adjustment members, each extending within a respective pocket and operably associated with a respective gripping element and adapted to move the gripping element relative to the top wall of the pocket.

38. The pipe joint restraint of claim 37, wherein the plurality of stops are circumferentially spaced-apart adjacent to the projecting rim.
